(19) United States
(12) Patent Application Publication
(10) Pub. No.: US 2026/0166821 A1
(43) Pub. Date: Jun. 18, 2026

(54) METHOD FOR LASER WELDING A PLURALITY OF ASSEMBLIES

(71) Applicant: BERGMANN & STEFFEN GMBH, Spenge (DE)

(72) Inventor: Uwe Bergmann, Melle (DE)

(21) Appl. No.: 19/124,340

(22) PCT Filed: Nov. 15, 2023
(86) PCT No.: PCT/EP2023/081879

§ 371 Date: Apr. 25, 2025

(30) Foreign Application Priority Data
Nov. 18, 2022 (EP) 22208246.3

(51) Int. Cl. B29C 65/00; B23K 26/03; B23K 26/062; B23K 26/067; H01M 50/516

(52) U.S. Cl. CPC B29C 66/73921; B23K 26/032; B23K 26/0626; B23K 26/067; H01M 50/516; H01M 2220/20

(57) ABSTRACT

A method for welding workpieces that form a large number of assemblies (C11-C29) arranged in at least one row, in which the workpieces are clamped together successively, one assembly at a time, with the help of at least two stepwise moving, alternating clamping frames (30, 32) and are welded together by a steerable laser beam source (48), in which the laser beam source (48) is moved synchronously with the clamping frame (30, 32), but continuously, along the at least one row of the assemblies.

The invention relates to a method for welding workpieces that form a plurality of assemblies arranged in at least one row, in which the workpieces are clamped together successively, one assembly at a time, with the help of at least two stepwise moving, alternating clamping frames and are welded together by means of a steerable laser beam source.

M ore particularly, the invention is concerned with a method for welding contact plates to cylindrical battery cells in a battery module formed by a plurality of cells.

A method of this type is known from CN 108 77 2638A, in which the laser beam source is arranged in a stationary manner above the rows of battery cells. By using two clamping frames working in push-pull, high productivity is achieved because one of the clamping frames can already be moved to the next position while the other clamping frame holds the workpieces that are currently being welded. The disadvantage, however, is that the laser beam hits the battery cells at the ends of the rows at a relatively large angle of incidence, which affects the efficiency of the energy transfer and the quality of the weld seam.

An alternative method is known from practice in which only a single clamping frame is assigned to each laser beam source and is moved step by step over the row of battery cells together with the laser beam source. The laser beam source can then be arranged so that the laser beam always hits the workpieces to be welded at a right angle. However, high productivity can only be achieved with this process by using several expensive laser beam sources. Another disadvantage is that the laser beam source has to be accelerated and stopped again in rapid alternation during the intermittent movement along the row of battery cells, so that the sensitive optics are exposed to high inertial forces.

The object of the invention is to provide a method that allows high productivity and the production of high quality weld seams with a given number of laser beam sources.

This object is achieved according to the invention in that the laser beam source is moved synchronously with the clamping frames, but continuously, along the at least one row of assemblies.

Since the laser beam source moves with the clamping frame, an approximately vertical incidence of the laser beam can be achieved on the entire row of assemblies, even when rows of assemblies are very long. Since the laser beam source is moved continuously, it is exposed to significantly lower mechanical stress. Although there is a certain relative movement between the laser beam source and the clamping frame, since the clamping frames advance intermittently, this relative movement can be compensated for with the help of the already steerable optics of the laser beam source that is available anyway.

Advantageous embodiments of the method are specified in the subclaims.

The clamping frames can work on parallel rows of assemblies or else in an overlapping manner on the same row.

The necessary movements of the clamping frames can be controlled using multi-axis robots. When processing cylindrical assemblies such as battery cells, the clamping frames can also be rotatable about an axis that runs parallel to the cylinder axes, so that adaptation to different orientations of the welding points is possible.

The movements of the clamping frames in the direction parallel to the axes of the cylindrical assemblies can be feedback-controlled in dependence on the force so that the workpieces are pressed against each other with an adjustable clamping force. This ensures sufficient contact pressure for each assembly individually and at the same time avoids mechanical overstressing of the workpieces. Optionally, a distance measurement can be carried out during the drive movement. In this way, it can be checked whether the positions of the workpieces in the direction parallel to the cylinder axes are within predetermined tolerance limits, and if this is not the case, an error signal can be output. On a carriage with which the laser beam source is continuously moved, there can be arranged at least one camera with which the position of the workpieces can be captured optically, so that even with certain tolerances in the arrangement of the workpieces, correct positioning of the clamping frames and precise targeting of the welding operation is possible. If the carriage is moved back and forth in order to process several rows of assemblies one after the other, a respective camera can be arranged on each, the leading and the trailing side of the carriage so that the optical capture of the workpieces and the necessary digital image processing can be carried out in good time before each welding takes place. The trailing camera can then be used, for example, for quality control of the weld seams.

A suction device for extracting welding gases can also be arranged on the carriage that carries the laser beam source. The suction device is then only exposed to low mechanical stress because it is moved continuously. Similarly, a gassing device for welding in a protective gas atmosphere can also be provided on the carriage.

The invention also relates to a welding device which is designed to carry out the method described above.

An exemplary embodiment is explained in more detail below by reference to the drawings, wherein:

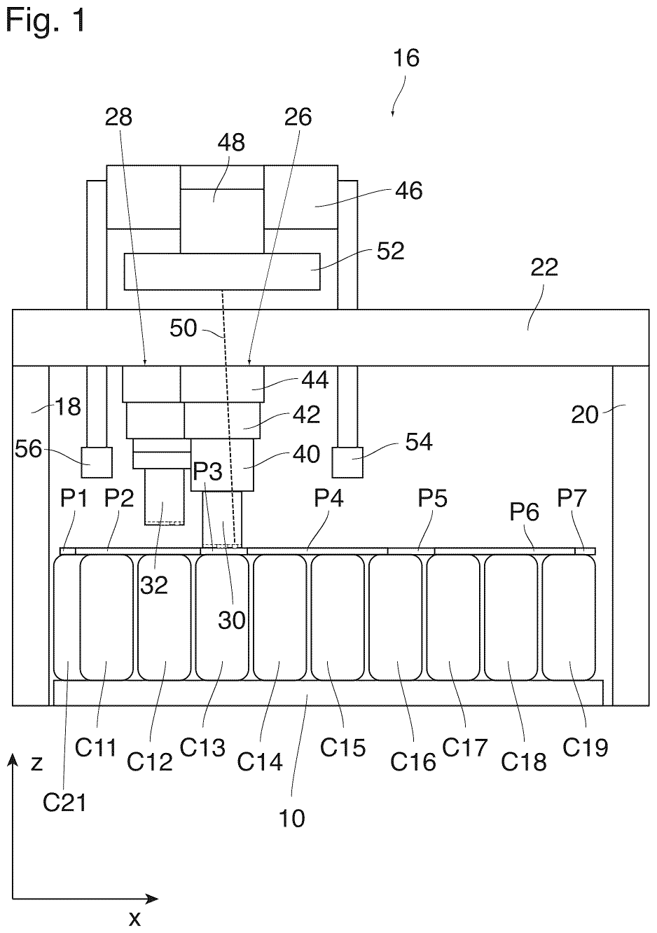

FIGS. 1 to 4 show schematic side views of a welding device according to the invention in different operating stages;

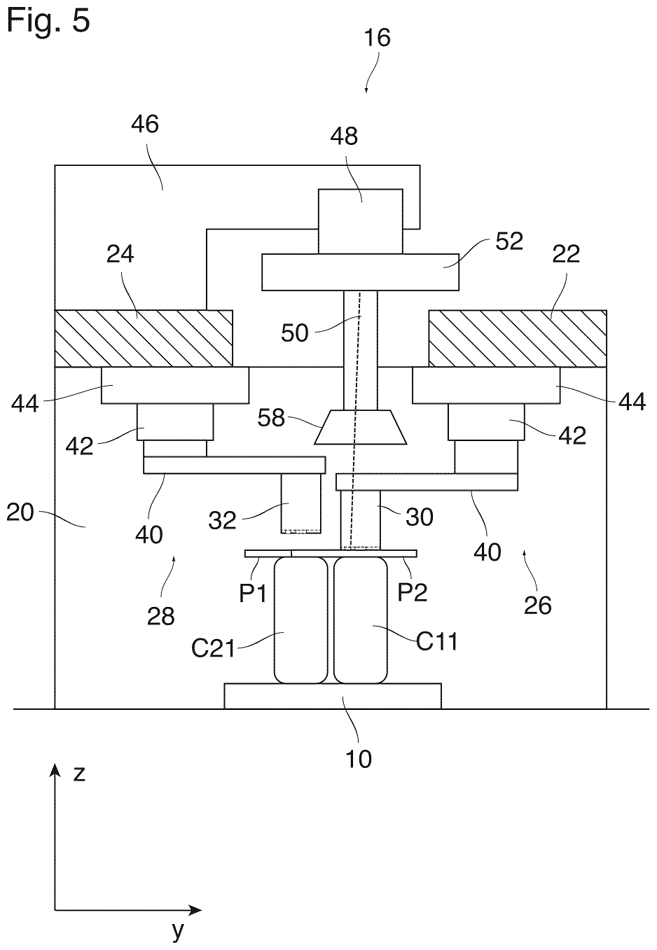

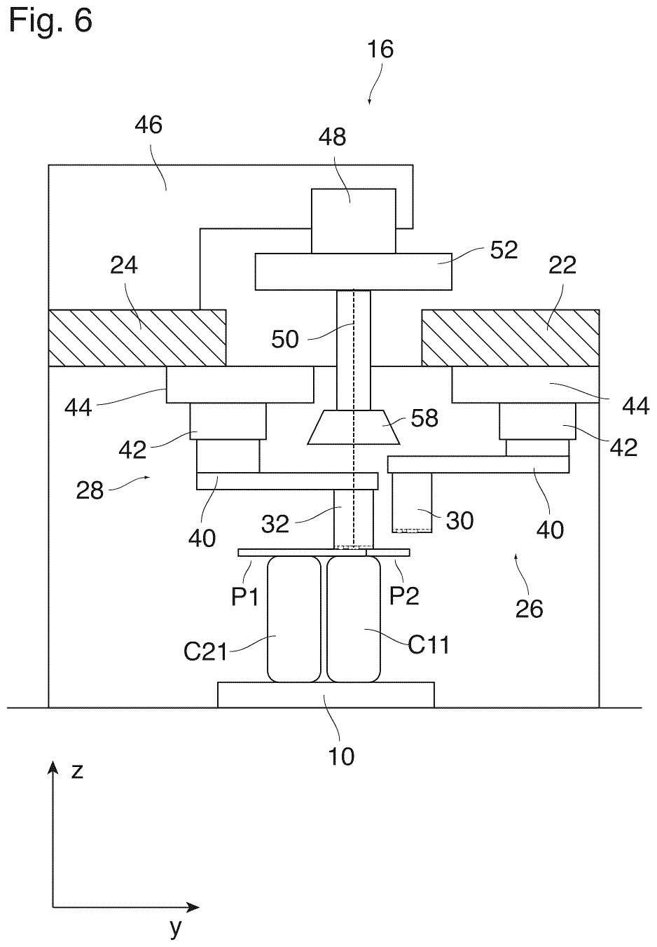

FIGS. 5 and 6 show schematic front views of the device in different operating stages;

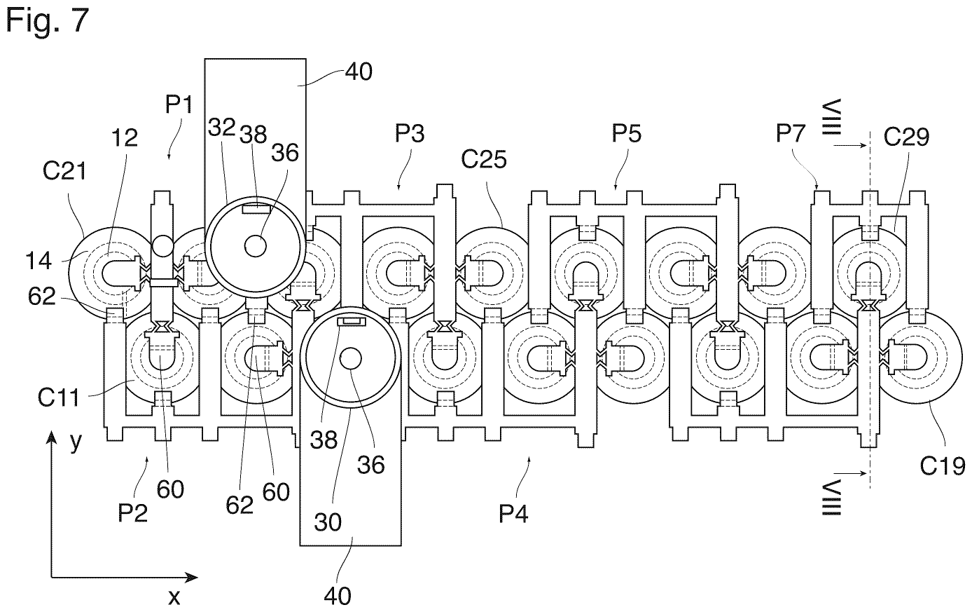

FIG. 7 shows two rows of battery cells and associated electrode plates in a top view, together with parts of the welding device;

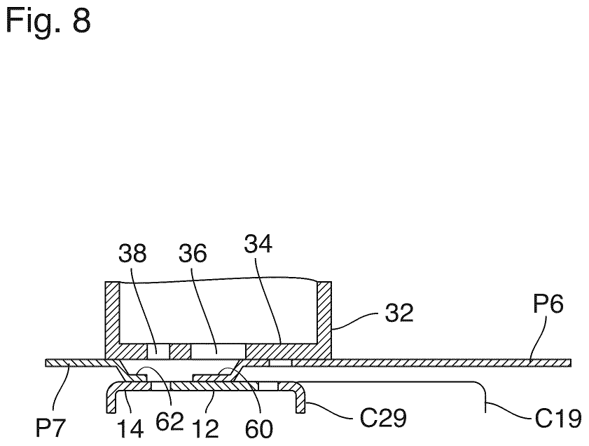

FIG. 8 shows a section along line VIII-VIII in FIG. 7; and

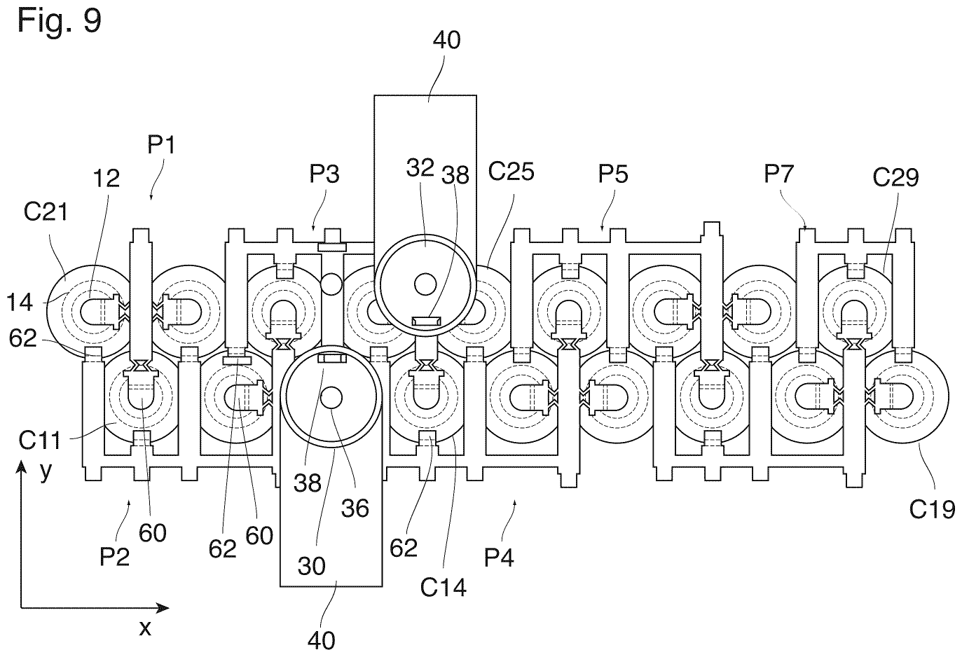

FIGS. 9 to 11 show views analogous to FIG. 7 for different operating stages of the device.

FIG. 1 shows a series of substantially cylindrical assemblies C11 to C19, which are arranged upright on a flat substrate 10. The substrate 10 can be a platform or a tray or optionally also a conveyor on which the assemblies are transported in and out in the direction perpendicular to the plane of the drawing in FIG. 1. In this example, the assemblies C11 to C19 are battery cells, which will be referred to below as “cells” C11 to C19. Of a second row of battery cells, which is located behind the row of cells C11 to C19, only one cell C21 can be seen in FIG. 1 at the left end of the row. In the reference numbers C11 . . . C19, C21, . . . , C29, the first digit (1 or 2) identifies the row, and the second digit (1 to 9) identifies the position of the cell in the row.

Although this is not visible in FIG. 1, each battery cell has at the top side a circular central electrode which forms a positive pole 12 and an annular electrode surrounding the positive pole 12 at a distance and forming a negative pole 14 and being electrically insulated from the positive pole 12 is (see FIG. 8).

In FIG. 1 there is also visible a row of electrode plates P1 to P7 (“workpieces” in the sense of claim 1), which rest on the two rows of battery cells and are to be connected according to a specific scheme, which will be explained in more detail later, to the plus and minus poles 12, 14 of the battery cells by laser welding. To carry out these welds, a welding device 16 as shown in FIG. 1 is provided, which straddles the substrate 10 and the rows of cells C11-C29 in the form of a portal. The portal has vertical end walls 18, 20, which rise on both sides of the substrate 10 and are connected to one another at the top by two cross-bars 22, 24. In FIG. 1, only the cros-bar 22 is visible. The second cros-bar 24 behind it can be seen, for example, in the front view in FIG. 5.

As FIG. 1 shows, the welding device 16 also has two positioning systems, for example robots 26, 28, each of which serves to manipulate a clamping frame 30 or 32 in several axes. The robot 26 can be moved along the cross-bar 22 in a direction x in which the rows of battery cells extend and is able to hold the clamping frame 30 in a position in which it is located above the first row of cells C11 to C19. Similarly, the robot 28 is movable in the direction x along the cross-bar 24 and is able to hold the clamping frame 32 in a position in which it is located above the same row of cells C11 to C19.

In the sectional view in FIG. 8, the clamping frame 32 is shown in a position above the cell C29. Each of the two clamping frames 30, 32 has an approximately cylindrical shape with a base 34 in which a central welding opening 36 and a peripheral welding opening 38 have been formed.

As FIG. 1 shows, the clamping frame 30 is held on a rotary drive 40, which in turn is held on a z-axis drive 42, which enables the clamping frame to move in a (vertical) direction z parallel to the axes of the cylindrical battery cells. The z-axis drive 42 is held on the underside of a y-axis drive 44, which in turn can be moved along the cross-bar 22 in the direction x parallel to the rows of battery cells. As is shown in FIG. 5, the clamping frame 32 is also held on the associated cross-bar 24 via a rotary drive 40, a z-axis drive 42 and a y-axis drive 44 and can be moved along it. The y-axis drives 44 allow the z-axis drives 42 and thus also the clamping frames 30, 32 to be moved in a direction y perpendicular to the rows of battery cells and perpendicular to the (vertical) z-axis. The z-axis n-drives 42 enable vertical movement of the clamping frames 30, 32 along the z-axis. The rotary drives 40 each have an overall L-shaped configuration with a vertical leg and a horizontal leg at the free end of which the clamping frame 30 or 32 is located. The rotary drives 40 can be designed, for example, as belt drives that are accommodated in the horizontal legs. With the help of these rotary drives 40, the cylindrical clamping frames 30, 32 can each be rotated about their axis, which runs parallel to the z-axis. The robots 26, 28 thus allow the axes of the cylindrical clamping frames 30, 32 to be aligned with the axis of a battery cell and then to rotate the clamping frame so that the welding openings 36, 38 assume a desired orientation.

A carriage 46 is mounted on the cross-bar 24 and can be moved continuously in the direction x along this cross-bar. A laser beam source 48 is held on an arm of the carriage 46 so that it is located above a gap between the two cross-bars 22, 24 (see FIG. 5). The laser beam source 48 is designed in a known manner to generate a high-energy laser beam 50, to focus this laser beam by means of a lens 52 onto a plane in which the plus and minus poles 12, 14 of the battery cells lie, and to steer this laser beam with the help of an electronically controlled mirror system to the plus or minus pole 12, 14 and to the part of one of the electrode plates P1 to P7 resting thereon, so that the relevant electrode plate and the battery pole are mechanically and electrically connected to one another by a weld.

FIG. 1 also shows two cameras 54, 56, which are arranged in front of and behind the robots 26, 28 in the direction x and allow to optically capture the position of the electrode plates P1 to P7 and the position of the battery cells. Digital image processing can then be used to generate control data for precise control of the robots 26, 28 and precise control of the mirror system of the laser beam source 48.

In the illustration in FIG. 5, the cameras 54, 56 have been omitted for the sake of clarity. Instead, FIG. 5 shows parts of a suction system or a combined suction and gassing system 58 which is also held on the carriage 46 and serves to fumigate the respective welding location with a protective gas and/or to exhaust the welding gases produced during the welding process. The parts of the suction and gassing system 58 are arranged in front of and behind the laser beam source 48 in the direction x so that they do not hinder the propagation of the laser beam 50 to the respective welding point.

In FIG. 1, the welding device 16 is shown in a state in which the clamping frame 30 is lowered onto the electrode plates P2 and P3 in order to clamp parts of these electrode plates against the plus or minus pole, respectively, of the cell C13. When the electrode plates and the cell are clamped in this manner, the laser beam 50 is directed sequentially to the positive pole and the negative pole of the cell C13 through the welding holes 36 and 38, to weld the battery poles to the electrode plates.

In a previous step, the clamping frame 32 clamped parts of the electrode plates P1 and P2 against the cell C12, and the poles of this cell have been welded to the electrode plates. In the stage shown in FIG. 1, however, the clamping frame 32 has been lifted by means of the z-axis-drive 42 and retracted in the direction normal to the plane of the drawing in FIG. 1 by means of the y-axis drive 44 so that it can now be moved in the direction x past the clamping frame 30.

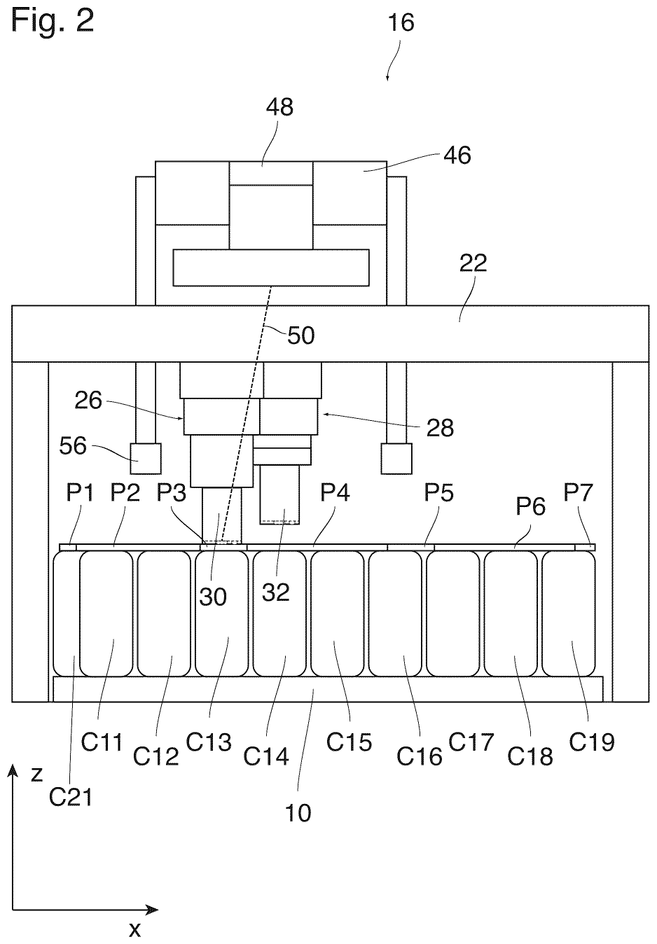

In FIG. 2, the robot 28 has reached a position in which it is aligned in the z direction with the next cell C14. The clamping frame 30 continues to hold the electrode plates P2 and P3 clamped against the cell C13, and the welding process is continued with the aid of the laser beam 50. Meanwhile, the carriage 46 was continuously moved in the direction x, so that the camera 56 has now moved a little closer to the robot 26. The relative movement of the carriage 46 relative to the robot 26 is continuously compensated for during the welding process by appropriate deflection of the laser beam 50.

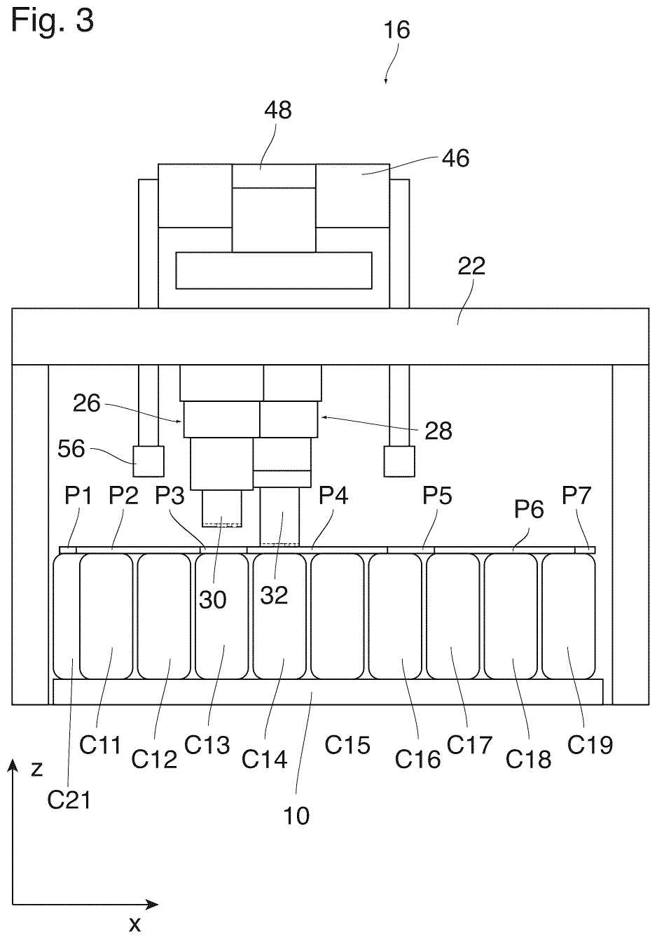

In FIG. 3, the welding process at cell C13 is completed. The clamping frame 30 was raised and moved back in the y-direction (towards the viewer). Meanwhile, the clamping frame 32 has been aligned with the axis of cell C14 and lowered onto this cell so that welding operations on this cell can now begin.

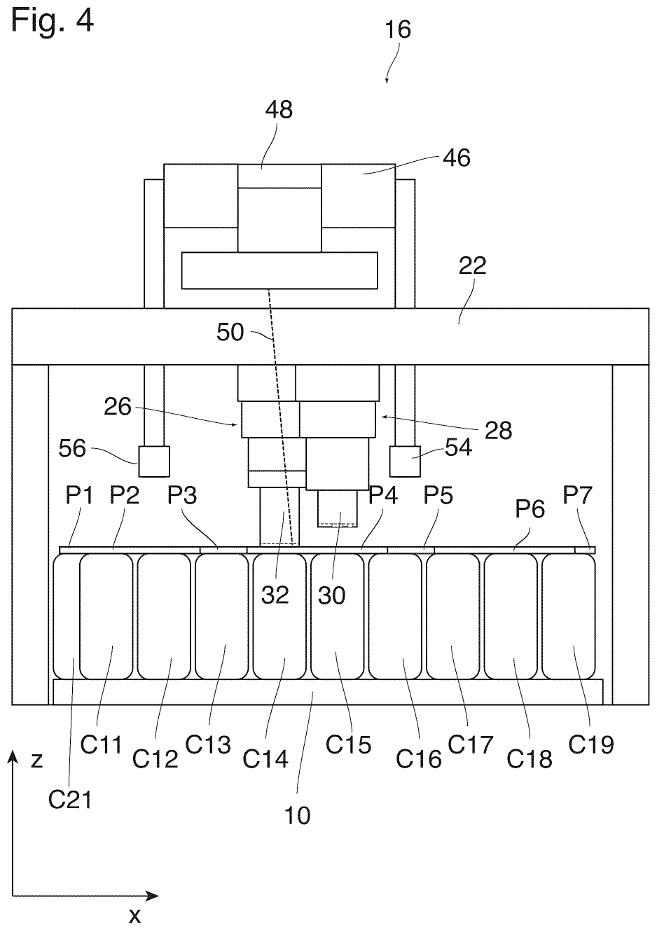

In FIG. 4, the welding process has begun at cell C14 and the clamping frame 30 has been moved in the x-direction to the position of cell C15. Meanwhile, the carriage 46 has continued to move continuously in the direction x, so that there is no collision between the robot 28 and the camera 54.

In this way, the robots 26 and 28 are moved step by step and alternatingly (in push-pull) in the direction x along the rows of battery cells, while the carriage 46 with the laser beam source 48 is tracking continuously. When the last cell C19 in the first row is reached, the welding device 16 and the substrate 10 are moved relative to each other in the direction y so far that the laser beam source and the robots are then above the second row of battery cells C21 to C29. The robots 26, 28 and carriage 46 then move in the x-direction to perform the welds on cells C29 to C21 in the second row. Again, the robots 26, 28 move step by step while the carriage 46 is moved continuously. The detection of the positions of the contact plates P1 to P7 and the battery cells is carried out in this phase by the camera 56 which runs ahead in this direction of movement. The trailing camera 54 can then be used to capture an image of the completed welds to inspect the quality of the welds.

In a modified embodiment, the clamping frames 30, 32 can also be designed in several parts. For example, two independently movable subframes can be provided for the two poles of the battery.

While in the example shown here each row of battery cells only has nine cells, in practice the number of cells per row can be significantly larger. Likewise, a significantly larger number of rows of cells can be arranged on the substrate 10.

The state of the welding device 16 shown in FIG. 5 corresponds to the state in FIG. 1, where the clamping frame 30 is lowered onto the battery cell C13 (which, however, is covered by the cell C11 in FIG. 5). The clamping frame 32 has moved back in the y-direction so that the horizontal arms of the rotary drives 40, which are directed towards one another, can move past each other in the x-direction.

The state in FIG. 6 corresponds to the state in FIG. 4, where the welding is carried out on the cell C14 while the electrode plates P3 and P4 are held by the clamping frame 32.

The robot 26 has lifted the clamping frame 30 and moved it back in the y-direction so that the rotary drives 40 do not collide with one another when moving in the x-direction. A possible contacting scheme for the electrode sheets and battery cells is shown in FIG. 7. In the (simplified) example described here, the positive poles of the cells C11, C21 and C22 are connected to one another by the electrode plate P1. For this purpose, the electrode plate P1 has three spring-loaded contacts 60 which are to be welded to the positive poles 12 of the cells and are offset in the z-direction. The negative poles 14 of these three cells are connected to the positive poles of the cells C12, C23 and C13 through the electrode plate P2. The electrode plate P2 therefore has spring-loaded contacts 60 for the positive poles and contacts 62, offset in the z-direction, for the negative poles 14.

Correspondingly, the electrode plate P3 connects the negative poles of this group of three cells with the positive poles of the next group of three, which is formed by the cells C24, C14 and C25. This scheme continues up to the electrode plate P6. The last electrode plate P7 connects the negative poles of the last group of three cells C18, C29 and C19.

The total of eighteen battery cells are thus connected together to form six groups of three cells, with the three cells in each group of three being connected in parallel with each other. In this way, a battery module is formed whose plus voltage tap is the electrode plate P1 and whose minus voltage tap is the electrode plate P7.

FIG. 8 shows the angled shape of the contacts 60 and 62 of the electrode plates P6 and P7, which contact the positive pole 12 and the negative pole 14 of the cell C29. When welding this cell, the clamping frame 32 is placed on this cell C29 so that its base 34 presses the contacts 60 and 62 against the battery poles, while the welding openings 36 and 38 allow the laser beam to pass through to the welding points.

In FIG. 7, the clamping frames 30 and 32 and the associated rotary drives 40 are shown in the same positions as in FIG. 1. The clamping frame 30 clamps the cell C13 and the associated electrode plates. In the previous step, the cell C12 and the associated electrode plates were clamped with the clamping frame 32, which is now retracted in the Y direction. The position of the peripheral welding opening 38 of the clamping frame 32 corresponds to the position of the contact 62 of the contact plate P3 belonging to the cell C12.

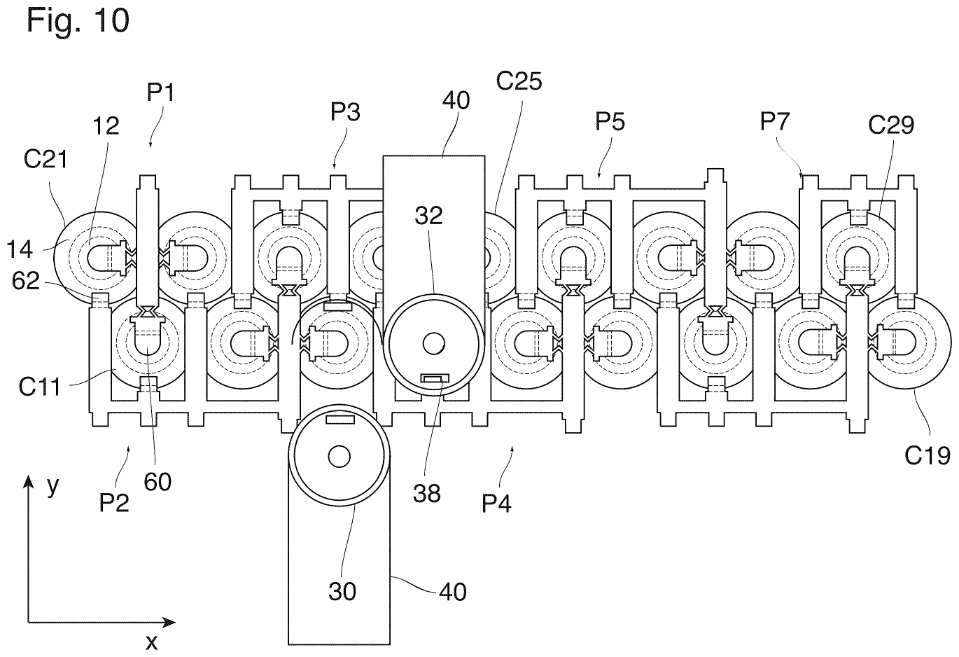

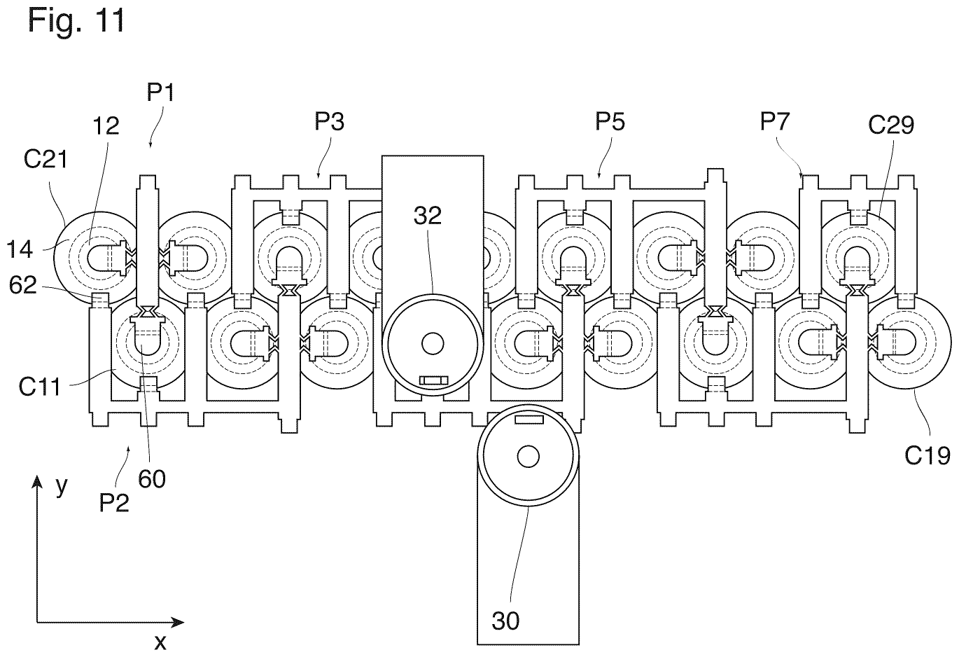

In FIG. 9, the clamping frame 32 has moved past the clamping frame 30 by one step in the x-direction, so that it is now at the level of the cell C14. With the help of the rotary drive 40, the clamping frame 32 was rotated 180° about its axis, so that the peripheral welding opening 38 now corresponds to the position of the contact 62 for the negative pole of the cell C14 as soon as the axis of the clamping frame 32 is aligned with the axis of this cell. In FIG. 10, this alignment has taken place, so that the welding opening 38 is now aligned with the contact. At the same time, the clamping frame 30 was retracted in the y-direction so that in the next step it can move past the clamping frame 32 to the position shown in FIG. 11. In the subsequent steps, the clamping frame 32 is rotated by 180° in each step, while the clamping frame 30 can maintain its angular position in this contacting scheme. However, contacting schemes are also conceivable in which the angular positions of both clamping frames have to be changed.

What is claimed is:

1. A method for welding workpieces that form a large number of assemblies arranged in at least one row, comprising the steps of:
clamping together the workpieces successively, one assembly at a time, with the help of at least two stepwise moving, alternating clamping frames
welding together the workpieces by a steerable laser beam source, and
moving the laser beam source synchronously with the clamping frame, but continuously, along the at least one row of the assemblies.

2. The method according to claim 1, in which the step of clamping together includes the step of moving the two clamping frames in an overlapping manner on the same row of assemblies.

3. The method according to claim 1, in which the step of clamping together includes the step of moving the two clamping frames independently of one another in at least two axes with the aid of respective robots.

4. The method according to claim 3,
wherein the assemblies are cylindrical assemblies with welding points that are arranged rotationally non-symmetrically to the cylinder axes thereof,
wherein the step of clamping together includes the step of adapting the clamping frames to different orientations of the welding points by rotating the clamping frames about an axis coaxial with the cylinder axis of the assembly by the respective robots.

5. The method according to claim 4, in which the assemblies are battery cells and wherein the step of welding includes the step of welding the workpieces together at positions of the welding points which are positions of contacts of electrode plates which are to be welded to plus and minus poles of the battery cells.

6. The method according to claim 2, in which the step of moving the two clamping frames includes the step of controlling movements of the clamping frames in a direction perpendicular to the at least one row of the assemblies in a force-dependent manner such that the workpieces to be welded are clamped against one another with an adjustable contact pressure.

7. The method according to claim 6, further comprising the step of checking the positions of the workpieces in the direction perpendicular to the row of assemblies, before the welding is carried out by measuring the path covered by the clamping frame in this direction.

8. The method according to claim 1, further comprising the steps of:
before each welding operation, capturing the positions of the workpieces with a digital camera and
determining necessary movements of the clamping frames and necessary deflections of the laser beam of the laser beam source by digital image processing.

9. The method according to claim 8, further comprising the step of, after a number of welding operations, checking the quality of the welds using a digital camera and using digital image processing.

10. The method according to any claim 1, further comprising the step of moving at least one of a suction device and/or a gassing device together with the laser beam source continuously in a direction parallel to the at least one row of the assemblies.

11. A welding device comprising:
a laser beam source, and
two clamping frames for clamping workpieces, and drive devices for moving the laser beam source and the clamping frame,
wherein the drive devices are configured for carrying out the method according to claim 1.
